(19) United States
(12) Patent Application Publication
(10) Pub. No.: US 2022/0234136 A1
(43) Pub. Date: Jul. 28, 2022

(54) MATERIAL PROCESSING BY MEANS OF A LASER BEAM IN A WOBBLE MOVEMENT

(71) Applicant: Precitec GmbH & Co. KG, Gaggenau (DE)

(72) Inventors: Rüdiger Moser, Malsch (DE); Tom Walde, Offenburg (DE); Stefan Birmanns, Rheinau (CH); Thomas Witt, Gaggenau (DE); Maurizio Kempf, Völkersweiler (DE)

(21) Appl. No.: 17/584,676

(22) Filed: Jan. 26, 2022

(30) Foreign Application Priority Data
Jan. 26, 2021 (EP) 21153490.4

(51) Int. Cl. B23K 26/06; B23K 26/082

(52) U.S. Cl. CPC B23K 26/0643; B23K 26/0626; B23K 26/082

(57) ABSTRACT

A system for machining materials by means of laser beam includes a deflection device for deflecting the laser beam and a wobble device configured to superimpose a wobble movement of the laser beam with a wobble figure and a wobble frequency onto a feed movement of the laser beam corresponding to a machining path by controlling the deflection device. The wobble device is configured, for carrying out the wobble movement, to control the deflection device according to a compensated wobble movement. Control values for a deflection of the laser beam along the wobble figure are adapted as a function of the wobble frequency and/or a path speed of the wobble movement that varies along the wobble figure is adapted as a function of a position of the laser beam in the wobble figure and as a function of the wobble frequency.

### CROSS-REFERENCE TO RELATED APPLICATIONS

This application claims priority to European application number 21 153 490.4 filed Jan. 26, 2021, the disclosure of which is hereby incorporated by reference in its entirety.

### FIELD OF THE INVENTION

The present invention relates to a system for material machining using a laser beam, comprising a deflection device for deflecting the laser beam; and a wobble device configured to superimpose a wobble movement of the laser beam according to a wobble figure and a wobble frequency on a feed movement of the laser beam corresponding to a machining path by controlling the deflection device.

### BACKGROUND OF THE INVENTION

US 2016/0368089 A1 describes a laser welding head including moveable mirrors for performing welding operations with wobble patterns.

DE 102019210618 A1 describes a laser material machining system, comprising: a material modification beam source for generating a process beam; a machining head coupled to the material modification beam source and including at least one process beam scanning actuator for directing and moving the process beam according to a wobble pattern in at least one axis at a machining location of a workpiece; and a control system for controlling at least the material modification beam source, the process beam scanning actuator, and an imaging beam scanning actuator, the control system being programmed to cause the machining head to scan the process beam in the wobble pattern. In one example, due to a smaller field of view and scan angle, a second mirror may be sized smaller to allow the second mirror to be moved at higher speeds.

EP 3157706 A1 describes a method for laser beam welding of at least two parts to be joined by means of optical seam tracking, the machining laser beam traveling along an optically detected leading edge according to a target weld seam profile by means of a scanner device as a laser beam guide device with at least one oscillating mirror. A high-frequency oscillating mirror oscillation adapted to component geometry conditions and/or process-related conditions is superimposed on the optical seam tracking by the scanner device.

### SUMMARY OF THE INVENTION

The system for material machining mentioned in the introduction may be a system for material machining, in particular for laser beam welding or cutting, which uses the deflection device, such as a scanner, to guide the laser beam with “figures” (e. g., circle, figure eight, etc.) over the workpiece. For this purpose, the shape of the “figure”, which defines a form of a wobble movement, is superimposed on a “primary” relative movement of the laser beam and the workpiece with the aid of the scanner. The primary relative movement between the workpiece and the laser beam may also be carried out by the scanner or by another movement device, such as a robot, a gantry or the like. The superimposition of a figure on this primary movement results in a positive formation of the weld seam, as this may influence the formation and width of the weld pool as well as the preheating and cooling of the base material or the welding material.

A weakness of conventional 2D scanner systems for superimposing the wobble movement on the primary relative movement of the laser beam and the workpiece with is that the size and geometry of a programmed figure changes at the higher wobble frequency at which the figure is generated by the scanner. An example of this is shown in FIG. 2.

It is an object of the invention to provide a system for material machining by means of a laser beam in which the above-described defect is eliminated or at least reduced.

The object is achieved by the subject matter disclosed herein. Advantageous embodiments and developments are also disclosed.

According to an aspect of the present disclosure, a system for material machining by means of a laser beam is provided, comprising: a deflection device for deflecting the laser beam; and a wobble device configured to superimpose a wobble movement of the laser beam including a wobble figure and a wobble frequency on a feed movement of the laser beam corresponding to a machining path by controlling the deflection device, wherein the wobble device is configured to control the deflection device for executing the wobble movement according to a compensated wobble movement, wherein control values for a deflection of the laser beam along the wobble figure are adapted as a function of the wobble frequency and/or a path speed varying along the wobble figure is adapted as a function of on a position of the laser beam in the wobble figure and the wobble frequency. In particular, control values for a deflection of the laser beam along the wobble figure may be adapted and stored as a function of the wobble frequency and may be used to control the deflection device according to the compensated wobble movement, and/or a path speed varying along the wobble figure may be adapted and stored as a function of a position of the laser beam in the wobble figure and the wobble frequency and used to control the deflection device according to the compensated wobble movement. In particular, the compensated wobble movement may include a predetermined compensation. The adapted control values may be stored, for example, in the wobble device or in a controller or in a memory or in software for a controller. The adapted path speed varying along the wobble figure may be stored, for example, in the wobble device or in a controller or in a memory or in software for a controller.

In this way, a figure reproduction error may be pre-compensated or minimized. Figure reproduction error refers to a deviation in the wobble figure, i.e. the shape or geometry, of the wobble movement from a desired wobble figure, the deviation arising due to the actual wobble figure depending on the wobble frequency during control of the deflection device. Therefore, in order to achieve the desired wobble figure or the desired wobble movement, the deflection device must be controlled according to a compensated wobble movement, in which a deflection of the laser beam and/or a path speed along the wobble figure is adapted as a function of the wobble frequency.

The feed movement may also be termed a relative movement of the laser beam and a workpiece. The wobble movement of the laser beam may denote a repetitive movement along a predetermined wobble figure at a predetermined wobble frequency. The wobble frequency may refer to the frequency at which the wobble figure is repeated during the wobble movement. The compensated wobble movement may be predetermined for a large number of wobble frequencies. For example, the compensated wobble movement may be determined experimentally and stored in a look-up table or memory.

Therefore, a deflection of the laser beam that corresponds to the desired wobble movement, in particular to the desired wobble figure, can be achieved by controlling the deflection device according to the compensated wobble movement. In particular a deflection of the laser beam along the desired wobble movement, in particular the desired wobble figure, can be achieved when controlling the deflection device according to the control values or figure reproduction errors can be reduced when the wobble movement is carried out with the path speed determined for the corresponding wobble frequency.

Superimposing may be denoted as modulating. The wobble movement thus modulates a position of the laser beam in at least one spatial dimension, preferably in at least two spatial dimensions, corresponding to a two-dimensional wobble figure.

Basically, a wobble movement of the laser beam to be obtained is defined by specifying a wobble figure and a wobble frequency. The wobble movement, which corresponds to the wobble figure, should be executed at the specified wobble frequency. By control according to the compensated wobble movement, the actual wobble movement can better approximate to the predetermined wobble figure, particularly in the case of relatively high wobble frequencies. A basic idea of the invention is, when the figure accuracy of the deflection (displacement) of the laser beam deteriorates with increasing wobble frequency, to counteract this effect, e.g. by targeted amplification of movement components depending on the position in the wobble figure. The compensated wobble movement may be understood as a theoretical wobble movement that would theoretically result when neglecting the effects of mass inertia and material resilience and neglecting the limitations of speeds of movements of the deflection device. In other words, controlling according to the compensated wobble movement may be understood as controlling with compensated control values. Herein, the terms deflection and displacement (of the laser beam) are used interchangeably.

Control values or control data for the compensated wobble movements may be stored in a memory, for example. Control values or control data for a respective compensated wobble movement may be output, for example, in the form of a sequence of control variables for controlling the deflection device.

Compensating for the figure reproduction error means that a predetermined compensation is carried out to compensate for an expected figure reproduction error. Thus, there is not only a reaction to a deviation from a desired movement, but the deflection device is controlled in advance based on the compensated wobble movement including the compensation. The compensation is thus anticipated. Irrespective thereof, the deflection device, the wobble device and/or a control device for outputting electrical control signals to the deflection device may have a closed-loop controller for executing the wobble movement; in this case, the compensation can not only achieve better figure accuracy, but also, for example, precompensation for a figure reproduction error that occurs with increasing wobble frequency can be achieved despite closed-loop control. In particular, a control error can be pre-compensated for.

Thus, reproduction errors of the wobble figure can be at least partially pre-compensated for. It is thus possible to counteract the effect of the size and geometry of a wobble figure changing with increasing frequency at which the corresponding wobble movement is generated by the deflection device. Such an effect may be caused, for example, by the mass inertia of moving parts of the deflection device since the inertia has a greater effect with increasing movement frequency and causes, at portions of the wobble figure, the current actual wobble position to lag behind the theoretical wobble position according to the movement along the wobble figure. Deviations of the real (actual) wobble movement from an ideal wobble movement corresponding to the wobble figure caused thereby may be counteracted in advance by providing different compensated wobble movements.

By improving the accuracy of the figures, process parameters such as laser power, wobble frequency and feed rate may also be increased linearly in certain areas at almost the same weld seam quality. The scalability of found process parameters can therefore be improved.

Thus, particularly at an increased machining speed, a corresponding increase in the wobble frequency may take place while largely maintaining the wobble figure, i.e. the size or amplitude and shape (geometry) of the wobble movement. For example, wobble frequencies in a range of less than 200 Hz and/or up to more than 500 Hz, in particular more than 600 Hz, may be used.

Furthermore, the used may be enabled to specify the wobble frequency in a wider range. In this way, for example, the melt pool dynamics can be specifically influenced.

In particular, the compensated wobble movement that deviates from an ideal wobble movement corresponding to the wobble figure can achieve high figure reproduction accuracy, i.e. a shape and size of the wobble movement that are as constant as possible, with increasing wobble frequency even when the system, for example to optimize the installation space and/or the size of the scan field, consists of two different deflection devices that have different inertias.

By providing different compensated wobble movements for different wobble frequencies, for example, the control of the deflection device may be calibrated for the respective wobble frequency so that the actual wobble movement approximates the desired wobble figure as close as possible. This can be done, for example, by experimentally determining compensated wobble movements or corresponding control values for at least one wobble figure to be used and for specific wobble frequencies such that figure and amplitude of the wobble movement remain approximately the same for all frequencies examined. Control values or data (e.g. control variables) for the compensated wobble movements may be stored, for example, in software for controlling the deflection device and may be used accordingly in the process. Furthermore, the control values for the respective compensated wobble movement, e.g. control variables for the behavior of the amplitudes, may be obtained by means of a suitable algorithm or alternative methods that can be automated, such as from the field of “artificial intelligence”.

A compensated wobble movement for a wobble frequency may be determined experimentally, for example, by the following method: A laser (pilot laser) machines a medium, for example a sheet of paper, according to a predetermined wobble movement. Optionally, a camera may record the machining trace, for example from the back of the medium. The machining step is repeated for different wobble frequencies and/or wobble figures, the control values or data (control variables) for the compensated wobble movement being varied. The control values for the compensated wobble movement are varied until the result obtained (the machining trace) fits the given wobble figure.

Wobble figures generated in this way may be measured at reference points, and further control variables may be interpolated between the reference points.

Control values for controlling the deflection device according to a compensated wobbling movement may, for example, comprise control variables for controlling the deflection device, in particular a sequence of control variables. A control variable may comprise, for example, an amplitude for controlling a deflection in a first direction. A control variable may comprise or define, for example, an amplitude for controlling a deflection in a first direction and an amplitude for controlling a deflection in a second direction. The second direction may be transverse or perpendicular to the first direction. In the case of a deflection or scanner mirror, the relevant amplitude for controlling the deflection may indicate a (target) deflection of the mirror.

The control variable may comprise a position or position vector indicating a location in a movement path of the compensated wobble movement. The location may indicate at least one coordinate for a deflection position of the laser beam. The position vector may be specified relative to a previous position vector in a sequence of control variables. The sequence of control variables may be specified, for example, for a sequence of supporting points of a movement path corresponding to the compensated wobble movement. A segment of the compensated wobble movement may be defined by a control variable or by a difference between successive control variables in the sequence of control variables, for example as a position vector. The number of supporting points or the length of the sequence of control variables may be, for example, in a range of up to 32 or more, preferably in a range of up to 64 or more, particularly preferably in a range of up to 128 or more.

The control variables may be defined for fixed times, e.g. fixed time intervals or points in time, for example according to a period length of the wobble movement divided by a length of the sequence of control variables (number of elements of the sequence). For example, a maximum possible number of supporting points over a specified path may result from a minimum size of time segments (time intervals between successive control variables) and a path speed specified by a user along the wobble path, for example. A path speed may be at least 1 m/s, for example. Time segments may be in a range down to 10 μs or less, for example.

The segments may be configured to be equidistant in time. Alternatively, in the sequence of control variables, a control variable may also include a point in time with respect to a reference time of the compensated wobble movement, or a path speed, for example a path speed associated with a respective segment. A path speed of the wobble movement may result from a predetermined time sequence of the control variables. For example, an instantaneous target path speed of the wobble movement may result from the position vector to be currently travelled and an associated time, wherein the time may be a fixed time interval. The (actual) path speed of the wobble movement may deviate from the target path speed. The path speed is understood here as the magnitude of the path velocity in the wobbling movement of the laser beam, i.e. as a directionless variable.

The compensated wobble movement may include a larger control value for a deflection of the laser beam at least in one direction of movement at a higher wobble frequency. In this way, for example, an inertia, e.g. of a scanner mirror, can be taken into account in the deflection.

The control values according to the compensated wobble movement may deviate depending on the wobble frequency by at least one overdriven amplitude of control values corresponding to the wobble figure at a lower wobble frequency. The amplitude may affect a part of the wobble figure or a movement section of the wobble movement. The overdrive or additional amplitude may increase with increasing wobble frequency. An amplitude (or movement amplitude) is understood here as a measure of a change in the wobble position in a single period of the (compensated) wobble movement, for example a maximum deflection of the wobble position from a mean position of the wobble figure.

In embodiments, the system for material machining by means of laser beam may further comprise: a control device for outputting electrical control signals to the deflection device based on control values for a compensated wobble movement, wherein the wobble device is configured to output control values for the respective compensated wobble movement to the control device for control of the deflection device by the control device.

The system for material machining by means of laser beam may comprise a process beam guiding device for guiding the laser beam relative to a workpiece according to the machining path.

For example, the wobble device may be implemented as a program, e.g., as software or a computer program. The wobble device may be part of the control device. The control device may, for example, be configured to carry out the function of the wobble device

The wobble figure to be used may be, for example, a predetermined wobble figure or a selectable, for example user-selectable, wobble figure.

Material machining by means of laser beam may include, for example, laser welding, laser metal deposition, 3D printing, laser cutting or laser soldering.

In embodiments, controlling the deflection device according to the compensated wobble movement comprises at least one of: compensating for an amplitude reduction of at least a portion of the wobble figure, in particular as a function of the wobble frequency; and compensating for a shape deviation of at least one portion of the wobble figure, in particular as a function of the wobble frequency. For example, without the compensation, as the wobble frequency increases, a figure reproduction error in the form of a reduced amplitude (extension) of a portion of the wobble figure and/or a figure reproduction error in the form of a deviation from the (overall) shape of the wobble figure may occur. The (pre-)compensation makes it possible to maintain the figure and amplitude to a large extent, even at increasing wobble frequencies.

In some embodiments, the compensated wobble movement used corresponds to the wobble figure scaled by a factor as a function of the wobble frequency. For example, the control values for a deflection of the laser beam along the wobble figure may be scaled with a factor dependent on the wobble frequency. The factor may be referred to as a scaling factor or stretch factor. The factor may have two components corresponding to an individually defined scaling in a first and a second direction, such as x and y. The factor may assume different values as a function of the wobble frequency. Preferably, a plurality of different compensated wobble movements are provided for different wobble frequencies and/or for different wobble figures, with the absolute values of the factor or of its components increasing with increasing wobble frequency. For example, at a low frequency of an intended range of wobble frequencies, the factor may equal 1, or each of its components may equal 1.

In embodiments, control values for a deflection of the laser beam along the wobble figure may be stored in a memory and/or in a table for different wobble frequencies.

For example, the compensated wobble movement may define or establish a path speed as a function of a position in the wobble figure. Thus, the precompensation may be carried out in such a way that the contour accuracy or figure accuracy increases, but the path speed may deviate from a specification at critical points of the figure, for example within defined limits. For this purpose, for example, in some portions (e.g., areas or segments of the figure), a path speed specification may first be varied within certain limits until a measured figure matches the desired figure as well as possible. These experimentally determined variations in path speed may then be stored in the control (i.e., in the wobble device) and may be used for the respective wobble figure and wobble frequency. In particular, corresponding control values or control data may be stored for the respective compensated wobble movement. For example, the varying path speed may, at least at one position of the wobble figure, exceed a path speed predetermined for the wobble figure and the relevant wobble frequency. For example, the varying path speed may exceed a tracking ability of the deflection device at least for one wobble frequency at at least one position of the wobble figure.

The deflection device may comprise a first deflection device and a second deflection device for deflecting the laser beam in different directions, respectively, for example said first direction and second direction. The deflection in a second direction may be independent of a deflection in a first direction and may be controllable. The deflection device may be a 2D deflection device, for example a 2D scanning system. The second direction may be shifted by 90° with respect to the first direction or may be shifted by an angle deviating from 90° with respect to the first direction. The first deflection device and the second deflection device may, for example, comprise a first scanner and a second scanner.

The deflection device may comprise at least one mirror. The deflection device may comprise a driving device, for example a galvanometer drive or a piezo drive. The deflection device may comprise at least one driving device for a respective mirror. For example, the first deflection device may include a driving device and a mirror and the second deflection device may include a driving device and a mirror. The respective driving device may include a galvanometer drive or a piezo drive, for example. For example, the respective deflection devices may cause a deflection in an X-direction (e.g. as the first direction) and, independently thereof, in a Y-direction (e.g. as the second direction).

The deflection device may comprise at least one galvanometer mirror. For example, the first deflection device may comprise a first (galvanometer) mirror and the second deflection device may comprise a second (galvanometer) mirror. The axes of rotation of the (galvanometer) mirrors may be arranged at right angles to one another or at an angle deviating from 90°. For example, the respective deflection devices may cause a deflection in an X-direction (e.g. as the first direction) and, independently thereof, in a Y-direction (e.g. as the second direction). A deflection device including a galvanometer mirror may also be referred to as a galvanometer scanner. Galvanometer mirrors work according to the galvanometer principle, wherein the mirror follows an applied current or electric field. Although the embodiment is described in relation to galvanometer mirrors, it is not limited thereto and the deflection device may also comprise a piezo-based driving device.

In embodiments, the deflection device may comprise a first deflection device and a second deflection device, the first deflection device being set up to deflect the laser beam in a first direction and the second deflection device being configured to deflect the laser beam in a second direction. The first direction may differ from the second direction or the first and second directions may be perpendicular to one another, i.e. form two axes of a Cartesian coordinate system. The first deflection device and the second deflection device may have substantially the same dynamic characteristics. For example, the first deflection device and the second deflection device may have substantially the same inertia and/or substantially the same stiffness. This facilitates the execution of a wobble movement true to figure. The first deflection device and the second deflection device may include or consist of substantially the same moving parts, i.e. may be constructed identically. In particular, the first deflection device and the second deflection device may each include a mirror of the same size and/or each include a driving device of the same type. This may ensure substantially the same dynamics for the two deflection devices.

Figure accuracy may be improved by constructing the deflection device, e.g. a 2D scanning system, as symmetrically as possible. For this purpose, the deflection device may be constructed from two identical deflection devices, so that mechanical characteristics thereof are largely identical. Alternatively, it is also possible to construct the two deflection devices differently, but in this case it must be ensured that their characteristics with regard to inertia and rigidity are largely identical and that they therefore have the same dynamic characteristics.

In addition, the contour accuracy may be improved by arranging the two (e.g. identical) deflection devices at a 90° angle to one another. Such a structure is optimal in terms of contour accuracy. Accordingly, the first direction and the second direction may be oriented at 90° to one another.

In embodiments, the wobble device may be further configured to control a power modulation of the laser beam as a function of a position in the wobble figure when controlling the deflection device according to the compensated wobble movement. A power modulation of the laser may bring about particularly advantageous characteristics of the wobbling movement in that the energy input can be defined spatially in an even more targeted manner. The energy input in the extent of the current machining point during its movement along the primary path (the machining path) may be controlled both by the wobble movement and also by the power modulation. For example, the system may include a modulation device for modulating the power of the laser beam and the wobble device may be configured to control a power modulation of the laser beam as a function of a position in the wobble figure by driving the modulation device. This function may be given by a fixed time profile of the compensated wobble movement.

According to a further aspect of the present disclosure, a method for material machining by means of a laser beam is provided, comprising: superimposing a wobble movement of the laser beam according to a wobble figure and a wobble frequency onto a feed movement of the laser beam corresponding to a machining path by deflecting the laser beam by means of a deflection device, wherein, for carrying out the wobble movement, the deflection device is controlled according to a compensated wobble movement in which control values for a deflection of the laser beam along the wobble figure are adapted as a function of the wobble frequency and/or a path speed of the wobble movement varying along the wobble figure is adapted as a function of a position of the laser beam in the wobble figure and as a function of the wobble frequency. In particular, control values for a deflection of the laser beam along the wobble figure may be adapted and stored as a function of the wobble frequency and may be used to control the deflection device according to the compensated wobble movement and/or a path speed variable along the wobble figure may be adapted and stored as a function of a position of the laser beam in the wobble figure and as a function of the wobble frequency and may be applied to control the deflection device according to the compensated wobble movement. In particular, the compensated wobble movement may include a predetermined compensation. The adapted control values may be stored, for example, in the wobble device or in a control or in a memory or in software for a control. The adapted path speed varying along the wobble figure may be stored, for example, in the wobble device or in a control or in a memory or in software for a control.

In a preceding calibration step, the control values for a deflection of the laser beam may be determined for a plurality of wobble frequencies such that, when the deflection device is controlled according to the control values, a deflection of the laser beam corresponds to the desired wobble movement, in particular the desired wobble figure. In a preceding calibration step, a path speed of the wobble movement varying along the wobble figure may also be determined for a plurality of wobble frequencies such that a figure reproduction error is reduced when the wobble movement is carried out with the path speed determined for the corresponding wobble frequency. In other words, for specific wobble figures and/or wobble frequencies, the control values or variables may be determined experimentally such that the wobble figure or the shape of the wobble movement remain the same for all wobble frequencies examined. Finally, these control values may be stored in the wobble device for controlling the deflection device and may be used accordingly in the method. Similarly, for specific wobble figures and/or wobble frequencies, path speeds along the wobble figure may be varied until the resulting wobble figure matches the desired wobble figure as well as possible. The path speeds varying along the wobble figure that have been thus determined may then be stored in the wobble device for controlling the deflection device and may be used in the method.

The method may be an operating method for a system for material machining by means of laser beam as described above.

### BRIEF DESCRIPTION OF THE DRAWINGS

The invention is described in detail below with reference to figures. In the figures:

FIG. 1 shows a schematic diagram of a system for material machining by means of laser beam according to embodiments of the present disclosure;

FIG. 2 shows a schematic diagram of the change in a wobble figure as a function of a wobble frequency with otherwise identical control values of deflection devices of a system for material machining by means of laser beam;

FIG. 3 shows a schematic diagram of a wobble figure as a function of a wobble frequency in a system for material machining according to embodiments of the present disclosure; and

FIG. 4 shows a schematic diagram of a deflection device in the form of a symmetrically configured 2D scanner of a system for material machining according to embodiments of the present disclosure.

### DETAILED DESCRIPTION OF THE INVENTION

Unless otherwise noted, the same reference symbols are used for identical and equivalent elements below.

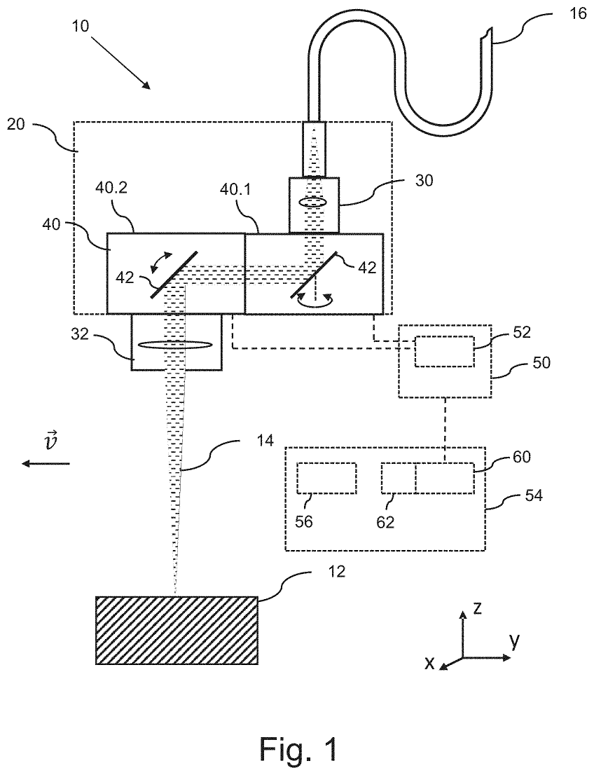

FIG. 1 shows a schematic diagram of a system for material machining by means of laser beam according to embodiments of the present disclosure. The system comprises a laser machining head 10 including a process beam guiding device 20 for guiding a laser beam 14 relative to a workpiece 12. The laser head has a feed speed \vec{v} relative to the workpiece 12, for example.

The laser machining head 10 is configured to focus or collimate a laser beam 14 emerging from a laser light source or an end of a laser optical fiber 16 with the aid of collimation and focusing optics 30, 32 onto a workpiece 12 to be machined in order to thereby carry out machining or a machining process. Machining may comprise laser cutting, soldering or welding, for example.

The laser machining head 10 includes a deflection device 40 in the form of a scanner module, such as a 2D scanner, for deflecting the laser beam 14 and for positioning the machining point of the laser beam 14 in the x-direction and y-direction.

The deflection device 40 comprises a first deflection device 40.1 for positioning the laser beam 14 in the x-direction and a second deflection device 40.2 for positioning the laser beam 14 in the y-direction. In the example shown, the deflection devices 40.1, 40.2 each include a galvanic mirror 42.

The system further comprises a control device 50 including driver electronics 52 for outputting analog electrical control signals to the deflection devices 40.1, 40.2 in order to control the galvanic mirrors 42. The control signals each have an amplitude which brings about a movement of the respective galvanic mirror 42 towards a corresponding deflection of the galvanic mirror 42.

The system further comprises a control computer 54 in which a wobble device 60 is implemented. The wobble device 60 is configured to output control values for a compensated wobble movement to the control device 50 so that the deflection device 40 can be controlled by the control device 50. The control computer 54 is configured to control a relative movement of the laser beam 14 and the workpiece 12 according to a primary machining path via the process beam guiding device 20. The wobble device 60 is configured to superimpose a wobble movement of the laser beam 14 corresponding to a wobble figure and a wobble frequency onto the relative movement by controlling the deflection device 40 via the control device 50. The wobble figure to be used is selected, for example, by a user and may be, for example, one of a circle, a figure eight, or another closed shape.

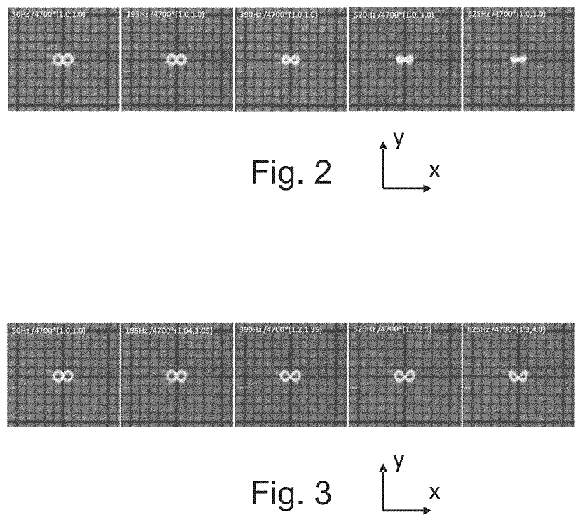

If a wobble movement corresponding to a same movement path or with same control commands is always used for a given wobble figure with increasing wobble frequency, the size and geometry (shape) of the wobble movement actually performed would change and, for example, would lag behind the desired wobble movement with regard to a movement amplitude. FIG. 2 shows this schematically as a comparative example of a wobble figure in the form of a figure eight. Shown from left to right are wobble movements with a wobble frequency of 50 Hz, 195 Hz, 390 Hz, 520 Hz and 625 Hz. A figure reproduction error is reflected in a reduced movement amplitude in the x-direction and especially in y-direction and thereby also comprises a changed geometry of the figure.

In FIG. 1, the wobble device 60 is configured to perform a precompensation for the figure reproduction error of the superimposed wobble movement that occurs with increasing wobble frequency. For this purpose, the wobble device 60 controls the deflection device 40 according to a compensated wobble movement which is a function of the wobble frequency and deviates from a generic wobble movement which corresponds to the wobble figure and does not take the wobble frequency into account.

FIG. 3 schematically shows the resulting wobble movements that are actually carried out. In this example, the compensated wobble movements are generated by multiplying the control values for a reference wobble movement at 50 Hz by respective stretch factors for the movement amplitudes. In each case, an x stretch factor and a y stretch factor are used, which may be different from one another.

The wobble movements at the same wobble frequencies as in FIG. 2 are shown in FIG. 3 from left to right, wherein the stretch factors (1.0; 1.0) are used at the wobble frequency of 50 Hz, the stretch factors (1.04; 1.09) are used at the wobble frequency of 195 Hz, the stretch factors (1.2; 1.35) are used at the wobble frequency of 390 Hz, the stretch factors (1.3; 2.1) are used at the wobble frequency of 520 Hz and the stretch factors (1.3; 4.0) are used at the wobble frequency of 625 Hz. Compared to FIG. 2 (without provision of stretch factors for the amplitudes), a significant improvement in the contour accuracy with regard to the specified wobble figure is apparent.

By providing the changed movement amplitudes, which may be stored in a memory 62, both the amplitude reductions shown in FIG. 2 and the associated shape deviation may be pre-compensated for. Due to the amplitudes of the control variables for the control device 50 being overdriven by the stretch factors, the actual wobble movement corresponds to the desired wobble movement since the control of the deflection device 40 is based on the compensated wobble movement. This may result in path speeds that vary in absolute value over the course of the wobble movement.

In FIG. 1, the control computer 54 may also be configured to control a power modulation of the laser beam 14 as a function of a position in the wobble figure by means of a power module 56. For this purpose, the power module 58 may control the laser light source, for example.

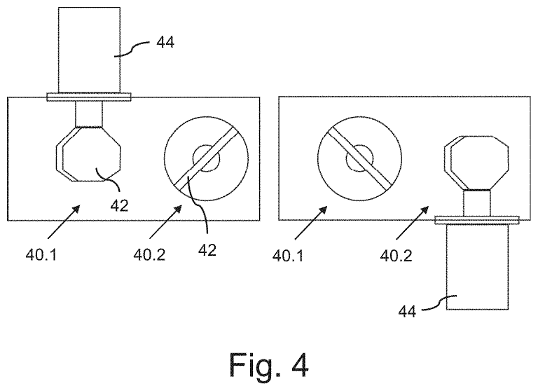

While, in the example in FIG. 3, the deflection devices 40.1 and 40.2 have mirrors 42 of different sizes so that different deviations in the movement amplitudes in x and y directions are required, FIG. 4 shows, in two views, an example of a symmetrically configured deflection device 40 of a further embodiment of a system for material machining by means of laser beam. The deflection device 40 of FIG. 4 has two symmetrically configured first and second deflection devices 40.1, 40.2, which in particular have mirrors 42 of the same size and galvanometer driving devices 44 of the same type for the mirrors 42. Due to the identical structure and the resulting identical dynamics of the two deflection devices 40.1 and 40.2, an even better precompensation for a shape deviation of the wobble movement may be achieved. Otherwise, the system may be configured similarly to the system in FIG. 1.

In the examples described, the adjustment angles of the deflection devices may be, for example, approximately 1°-2°, with deflections of the laser beam, for example, in the range of 10 mm to 20 mm. For a wobble movement with an amplitude in the range of 1 mm to 2 mm, for example, this results in deflection angles for wobbling of about 5-10 arc minutes.

1. A system for machining materials by means of laser beam, comprising:
a deflection device for deflecting the laser beam; and
a wobble device configured to superimpose a wobble movement of said laser beam with a wobble figure and a wobble frequency onto a feed movement of said laser beam corresponding to a machining path by controlling said deflection device;
wherein;
said wobble device is configured, for carrying out the wobble movement, to control said deflection device according to a compensated wobble movement; and
control values for a deflection of said laser beam along the wobble figure are adapted as a function of the wobble frequency and/or a path speed of the wobble movement that varies along the wobble figure is adapted as a function of a position of said laser beam in the wobble figure and as a function of the wobble frequency.

2. The system according to claim 1, wherein controlling said deflection device according to the compensated wobble movement comprises at least one of: compensating for a reduction in amplitude of at least a portion of the wobble figure as a function of the wobble frequency; and compensating for a shape deviation of at least a portion of the wobble figure as a function of the wobble frequency.

3. The system according to claim 1, wherein the control values for a deflection of said laser beam along the wobble figure are scaled with a factor dependent on the wobble frequency.

4. The system according to claim 1, wherein control values for a deflection of said laser beam along the wobble figure are stored in a memory and/or in a table for different wobble frequencies.

5. The system according to claim 1, wherein said deflection device comprises a first deflection device and a second deflection device, wherein said first deflection device is configured to deflect said laser beam in a first direction, said second deflection device is configured to deflect said laser beam in a second direction, and wherein said first deflection device and said second deflection device have substantially the same dynamic characteristics.

6. The system according to claim 1, wherein said deflection device comprises a first deflection device and a second deflection device, wherein said first deflection device is configured to deflect said laser beam in a first direction, said second deflection device is configured to deflect said laser beam in a second direction, and wherein said first deflection device and said second deflection device are configured substantially identically.

7. The system according to claim 1, wherein said deflection device comprises a first deflection device and a second deflection device, said first deflection device is configured to deflect said laser beam in a first direction, said second deflection device is configured to deflect said laser beam in a second direction, and wherein said first deflection device and said second deflection device are arranged at an angle of 90° to one another.

8. The system according to claim 1, wherein said wobble device is configured to control a power modulation of said laser beam as a function of a position of said laser beam in the wobble figure.

9. A method for material machining by means of a laser beam, comprising:
superimposing a wobble movement of the laser beam according to a wobble figure and a wobble frequency onto a feed movement of said laser beam corresponding to a machining path by deflecting said laser beam by means of a deflection device;
wherein;
for carrying out the wobble movement, said deflection device is controlled according to a compensated wobble movement; and
control values for a deflection of said laser beam along the wobble figure are adapted as a function of the wobble frequency and/or a path speed of the wobble movement that varies along the wobble figure is adapted as a function of a position of said laser beam in the wobble figure and as a function of the wobble frequency.

10. The method according to claim 9, wherein:
in a preceding calibration step, control values for a deflection of said laser beam are determined for a plurality of wobble frequencies such that, when said deflection device is controlled according to the control values, a deflection of said laser beam corresponds to the desired wobble movement, in particular the desired wobble figure; and/or
wherein, in a preceding calibration step, a path speed of the wobble movement that varies along the wobble figure is determined for a plurality of wobble frequencies such that, when the wobble movement is carried out with the varying path speed determined for the corresponding wobble frequency, a figure reproduction error is reduced.
